(19) United States
(12) Patent Application Publication
(10) Pub. No.: US 2009/0089465 A1
(43) Pub. Date: Apr. 2, 2009

(54) Plug and Play Display Device Over Ultra Wideband Link

(76) Inventors: David W. Douglas, Austin, TX (US); Pratik M. Mehta, Austin, TX (US); Bruce Montag, Austin, TX (US)

Correspondence Address: HAMILTON & TERRILE, LLP, P.O. BOX 203518, AUSTIN, TX, 78720, US

(21) Appl. No.: 11/862,221

(22) Filed: Sep. 27, 2007

(51) Int. Cl. G06F 13/38

(52) U.S. Cl. 710/65; 345/522; 710/62

(57) ABSTRACT

A method for conveying display device data over an ultra wideband wireless link that provides an information handling system with an information handling system ultra wideband communication link. The method also provides a display device with a display device ultra wideband communication link and transmits display data between the information handling system ultra wideband communication link and the display device ultra wideband communication link.

### BACKGROUND OF THE INVENTION

1. Field of the Invention

The present invention relates to information handling systems and more particularly to plug-n-play display devices used with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known for an information handling system display device (e.g., a monitor) to convey its capabilities to a host's graphics card via a bi-directional communication path such as a display data channel (DDC) communication path. Generally, the communication path includes dedicated clock and data lines. Alternately, in the case of a DisplayPort type communication path, a virtual DDC is provided via an auxiliary channel. Data such as extended display identification data (EDID) is transmitted via the DDC channel to convey the capabilities and characteristics (e.g. resolution support, power management, color characteristics etc.) of the display device. For example, FIG. 1, labeled Prior Art, shows the operation of the communication between an information handling system and a display device.

An issue is presented with information handling systems that communicate wirelessly as there is no dedicated set of wired lines. Accordingly, wireless information handing systems may not include a display data channel. In known systems, display device data exchange is defined only for wired video cable interfaces such as video graphics array (VGA), digital video interactive (DVI), and DisplayPort (DP) connectors.

Accordingly, it would be desirable to provide a method of conveying display device data to a display device over a wireless link.

### SUMMARY OF THE INVENTION

In accordance with the present invention, a system and method for conveying display device data (including for example, Plug-N-Play data) over a wireless link is set forth. In certain embodiments, the display device data can include data regarding the capability of the display device to a graphics subsystem of an information handling system over a wireless link.

More specifically, in accordance with the present invention, a method for transmitting EDID over an ultra wideband (UWB) communication link is set forth. In the case of UWB dongles (i.e., a connector that converts a video signal to a UWB signal) connected via VGA, DVI, or DP, the dongle translates (i.e., encodes and decodes) the EDID call from the information handling system and the responding transmission of EDID from the monitor. This method utilizes known wired standards for fetching EDID but attaches a UWB transceiver on each end of the transmission (i.e., on the information handling system end and on the display device end) capable of encoding and decoding the transmitted information.

In the case of a multifunction UWB, transceiver built into a Notebook and fully integrated into a monitor, the UWB link functions as a virtual Display Data Channel. More specifically, after the UWB link has been established, a wireless aware graphics driver negotiates an Extension call (e.g., within the video BIOS) for EDID and the UWB module transmits the message. The Monitor receives, decodes and interprets the EDID call and in turn transmits the EDID back over the UWB link. The graphics driver within the information handling system receives the data, enumerates the display, and updates registry values accordingly.

In one embodiment, the invention relates to a method for conveying display device data over an ultra wideband wireless link which includes providing an information handling system with an information handling system ultra wideband communication link, providing a display device with a display device ultra wideband communication link, and transmitting display data between the information handling system ultra wideband communication link and the display device ultra wideband communication link.

In another embodiment, the invention relates to an information handling system. The system includes a processor, an ultra wideband communication link, and memory coupled to the processor. The memory stores a wireless video application that conveys display device data over the ultra wideband wireless link. The wireless video application includes instructions for transmitting display data between the information handling system ultra wideband communication link and a display device ultra wideband communication link.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1, labeled Prior Art, shows a flow chart of a communication between an information handling system and a display device.

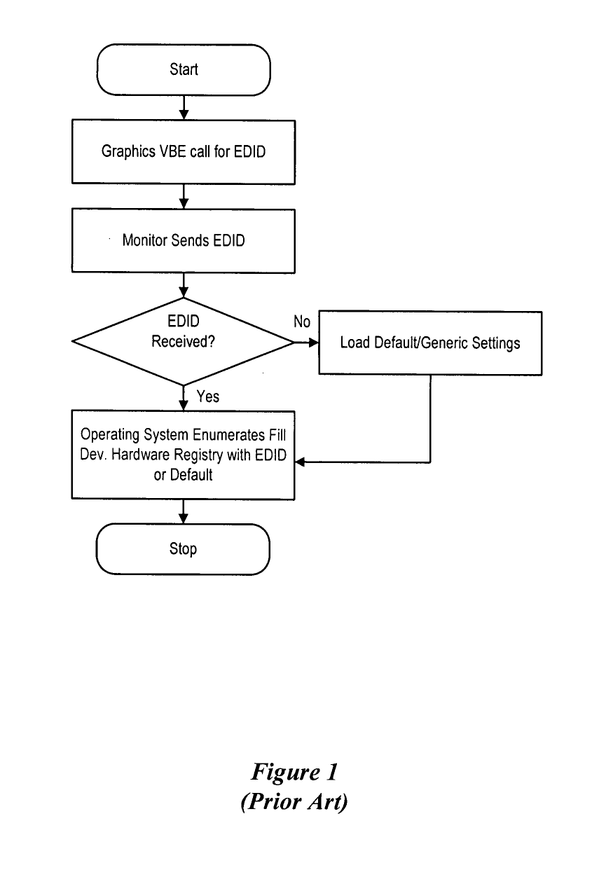

FIG. 2 shows a block diagram of wireless communication between an information handling system and a wireless monitor.

FIG. 3 shows a block diagram of an information handling system.

FIG. 4 shows a flow chart of the operation of a communication between an information handling system and a wireless monitor.

FIG. 5 shows a block diagram of an information handling system having a graphics subsystem.

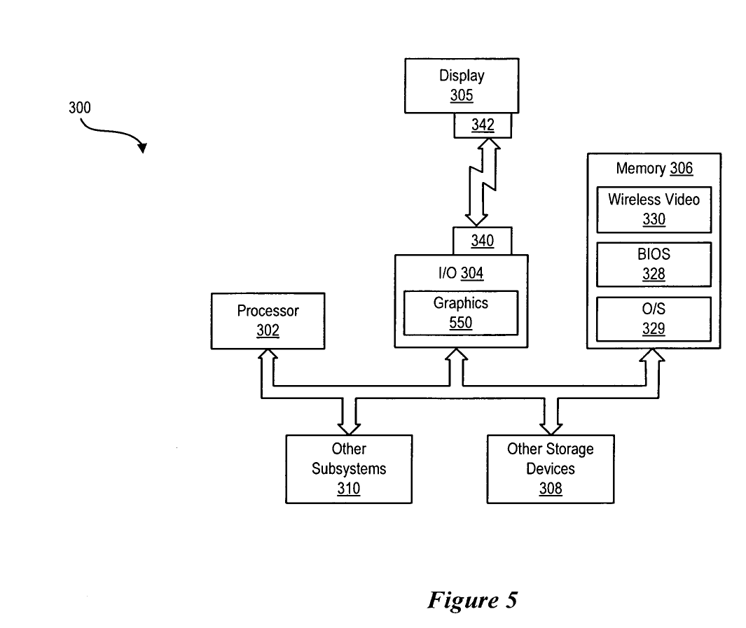

### DETAILED DESCRIPTION

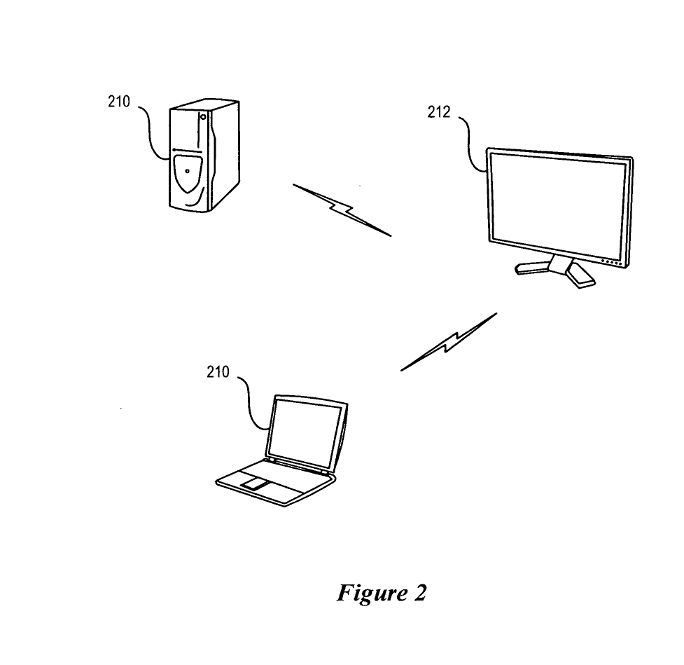

Referring to FIG. 2, a block diagram of wireless communication between an information handling system 210 and a wireless monitor 212 (i.e., a display device) is shown. The information handling system may be a tower or desktop type information handling system 210a or a portable information handling system 210b. The information handling system 210 includes a system for conveying display device data (including for example, Plug-N-Play data) over a wireless link 220. In certain embodiments, the display device data can include data regarding the capability of the display device 212 to a graphics subsystem of an information handling system 210 over the wireless link 220.

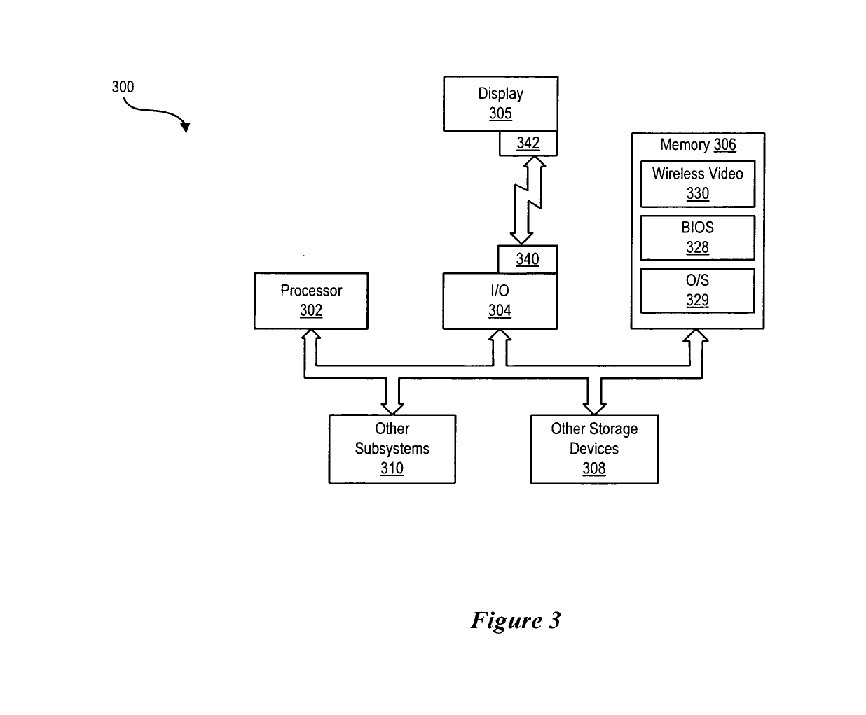

Referring to FIG. 3, a system block diagram of an information handling system 300 is shown. The information handling system 300 includes a processor 302, input/output (I/O) devices 304 (including associated controllers), such as a display 305, a keyboard, a mouse, and associated controllers, memory 306 including non-volatile memory such as a hard disk drive and volatile memory such as random access memory, and other storage devices 308, such as an optical disk and drive and other memory devices, and various other subsystems 310, all interconnected via one or more buses, shown collectively as bus 312.

The memory 306 also includes a basic input output system 328 and an operating system 329 as well as a wireless video application 330. The BIOS 328 and the operating system 329 include instructions for executing on the processor 302. The wireless video application 330 includes instructions that are executed by the processor 302 to enable wireless operation of a display device. In certain embodiments, the wireless video application 330 includes a system for transmitting EDID over an ultra wideband (UWB) communication link.

The information handling system 300 also includes dongles 340, 342 that convert video signals to UWB signals. With the dongles 340, 342 (i.e., connectors that translate video signals to UWB signals) connected via VGA, DVI, or DP, the dongle translates (i.e., encodes and decodes) the EDID call from the information handling system 300 and the responding transmission of EDID from the display 305. The information handling system 300 utilizes known wired standards for fetching EDID but provides a UWB transceiver (e.g., via the dongles 340, 342) on each end of the transmission (i.e., on the information handling system end and on the display device end) capable of encoding and decoding the transmitted information.

In certain embodiments, a multifunction UWB transceiver may be built into a portable information handing system (e.g., into the I/O controller 304) and additionally, may be fully integrated into a monitor, the UWB link functions as a virtual Display Data Channel. More specifically, after the UWB link has been established, a wireless aware graphics driver negotiates an extension call (e.g., within the video BIOS) for EDID and the UWB module transmits the message. The display 305 receives, decodes and interprets the EDID call and in turn transmits the EDID back over the UWB link. A graphics driver within the information handling system 300 receives the data, enumerates the display, and updates registry values accordingly.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

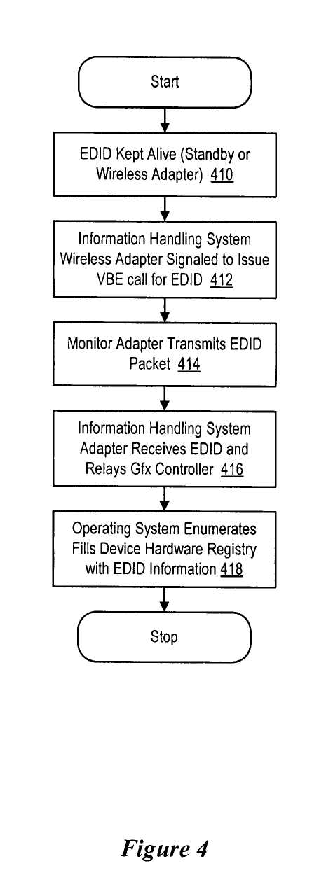

Referring to FIG. 4 shows a flow chart of the operation of a communication between an information handling system and a wireless monitor using the wireless video application 320 is shown. More specifically, the communication starts by the information handling system keeping the EDID function alive (using for example either a standby mode of operation or a wireless adapter operation) at step 410. Next at step 412, the wireless application 330 causes the information handling system wireless adapter (e.g., dongle 340) to issue a VBE call for the EDID function. Next at step 414, the monitor adapter (e.g., dongle 342) transmits an EDID packet.

Next, the information handling system adapter receives the EDID packet and relates this information to a graphics controller (which may be located within I/O 304) at step 416. Next, the operating system 329 enumerates and fills the device hardware registry with the EDID information at step 418.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules (which may be instantiated within firmware) that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, in certain embodiments, the I/O devices 304 can include a graphics subsystem 550. The graphics subsystem 550 may execute instructions and may include memory (including firmware) on which software such as the wireless video application 330 is stored. The graphics subsystem 550 can control the dongles 340, 342 or a build in UWB transceiver.

Consequently, the invention is intended to be limited only by the spirit and scope of the appended claims, giving full cognizance to equivalents in all respects.

What is claimed is:

1. A method for conveying display device data over an ultra wideband wireless link comprising:
providing an information handling system with an information handling system ultra wideband communication link;
providing a display device with a display device ultra wideband communication link; and,
transmitting display data between the information handling system ultra wideband communication link and the display device ultra wideband communication link.

2. The method of claim 1 wherein:
the display device data comprises data regarding a capability of the display device to a graphics subsystem of the information handling system.

3. The method of claim 1 wherein:
the display device data comprises extended display identification data (EDID).

4. The method of claim 1 wherein:
the information handling system ultra wideband communication link translates a video signal to a UWB signal; and,
the display device ultra wideband communication link translates a UWB signal to a display device signal.

5. The method of claim 1 wherein:
the information handling system UWB communication link is integrated within the information handling system; and,
the display device UWB communication link is integrated within the display device.

6. The method of claim 1 wherein:
the information handling system UWB communication link functions as a virtual Display Data Channel which comprises the steps of
after a UWB link has been established, a wireless aware graphics driver negotiates an Extension call for EDID and the UWB module transmits the message;
the monitor receives, decodes and interprets the EDID call and in turn transmits the EDID back over the UWB link; and
the graphics driver within the information handling system receives the data, enumerates the display, and updates registry values accordingly.

7. The method of claim 6 wherein:
after a UWB link has been established, a wireless aware graphics driver negotiates an extension call for extended display identification data (EDID) and the information handling system UWB communication link transmits the call; and,
the display device UWB communication link translates the EDID call; and,
the wireless aware graphics driver receives the EDID, enumerates the display device, and updates registry values within the information handling system to reflect the EDID.

8. An information handling system comprising:
a processor;
an ultra wideband communication link;
memory coupled to the processor, the memory storing a wireless video application, the wireless video application conveying display device data over the ultra wideband wireless link, the wireless video application comprising instructions for:
transmitting display data between the information handling system ultra wideband communication link and a display device ultra wideband communication link.

9. The information handling system of claim 8 wherein:
the display device data comprises data regarding a capability of the display device to a graphics subsystem of the information handling system.

10. The information handling system of claim 8 wherein:
the display device data comprises extended display identification data (EDID).

11. The information handling system of claim 8 wherein:
the information handling system ultra wideband communication link translates a video signal to a UWB signal; and,
the display device ultra wideband communication link translates a UWB signal to a display device signal.

12. The information handling system of claim 8 wherein:
the information handling system UWB communication link is integrated within the information handling system; and,
the display device UWB communication link is integrated within the display device.

13. The information handling system of claim 8 wherein:
the information handling system UWB communication link functions as a virtual Display Data Channel which comprises the steps of
after a UWB link has been established, a wireless aware graphics driver negotiates an Extension call for EDID and the UWB module transmits the message;
the monitor receives, decodes and interprets the EDID call and in turn transmits the EDID back over the UWB link; and
the graphics driver within the information handling system receives the data, enumerates the display, and updates registry values accordingly.

14. The information handling system of claim B6 wherein:
after a UWB link has been established, a wireless aware graphics driver negotiates an extension call for extended display identification data (EDID) and the information handling system UWB communication link transmits the call; and,
the display device UWB communication link translates the EDID call; and,
the wireless aware graphics driver receives the EDID, enumerates the display device, and updates registry values within the information handling system to reflect the EDID.
